(19) United States
(12) Patent Application Publication
(10) Pub. No.: US 2014/0169899 A1
(43) Pub. Date: Jun. 19, 2014

(54) LOW PROFILE TURBINE MAINTENANCE DEVICE

(71) Applicant: GENERAL ELECTRIC COMPANY, Schenectady, NY (US)

(72) Inventor: Andrzej Laciak, Lemont, IL (US)

(73) Assignee: GENERAL ELECTRIC COMPANY, Schenectady, NY (US)

(21) Appl. No.: 13/719,721

(22) Filed: Dec. 19, 2012

(51) Int. Cl. B23B 45/00; B23B 45/04; B23B 31/20

(52) U.S. Cl. CPC B23B 45/00; B23B 31/20; B23B 45/042
USPC 408/125; 279/95; 279/43.1

(57) ABSTRACT

Systems and devices adapted to provide a low profile drilling and reaming tool/device are disclosed. In one embodiment, a device includes: a base housing; a fixture head connected to the base housing, the fixture head including an aperture therethrough; a rotational connector disposed within the aperture and configured to rotate within the aperture; and a fixture slidingly connected to the fixture head via the rotational connector, the fixture extending through the aperture.

### BACKGROUND OF THE INVENTION

The subject matter disclosed herein relates to machines and, more particularly, to systems for performing maintenance processes and/or procedures (e.g., bucket removal, bucket replacement, drilling, reaming, etc.) on turbomachines.

Some power plant systems, for example, certain nuclear, simple-cycle and combined-cycle power plant systems, employ turbines in their design and operation. These turbines include a plurality of components including turbine buckets, rotors, etc. which are precisely positioned and disposed at tight clearances relative one another. During maintenance procedures, it may be difficult for technicians to access some of these turbine components as a result of their location and proximity to other components (e.g., adjacent wheels, buckets, blades, turbine shells, etc.). The tight clearances between turbine rotor components may require that a number of tools, fittings, and/or processes (e.g., custom drill bits, custom reamers, etc.) be used in order to perform maintenance processes. The multiple tools may include a variety of lengths and attachments which are switched in and out of the process by technicians in order to adjust/accommodate for clearance and component variation during maintenance. These custom tools enable technicians to drill holes of varied depth and to perform maintenance operations within very tight clearances of the turbine with minimal disassembly. However, the repeated switching of tools and components greatly increases system downtime and maintenance process duration, and the number of custom tools and attachments required for these processes may complicate maintenance procedures, limit on-site processes, and increase maintenance cost.

### BRIEF DESCRIPTION OF THE INVENTION

Systems and devices adapted to perform maintenance processes on turbomachines are disclosed. In one embodiment, a device includes: a base housing; a fixture head connected to the base housing, the fixture head including an aperture therethrough; a rotational connector disposed within the aperture and configured to rotate within the aperture; and a fixture slidingly connected to the fixture head via the rotational connector, the fixture extending through the aperture.

A first aspect of the disclosure provides a device which includes: a base housing; a fixture head connected to the base housing, the fixture head including an aperture therethrough; a rotational connector disposed within the aperture and configured to rotate within the aperture; and a fixture slidingly connected to the fixture head via the rotational connector, the fixture extending through the aperture.

A second aspect provides a system including: a turbine; a device connected to the turbine, the device including: a base housing, and a fixture head connected to the base housing, the fixture head defining an aperture through the device; a rotational connector disposed within the aperture and operably connected to the device, the rotational connector configured to rotate within the aperture; and a fixture configured to slidingly connect to the fixture head at a plurality of locations via the rotational connector, the fixture further configured to extend through the aperture.

A third aspect provides a device including: a rotational connector configured to connect to a fixture head and define an aperture there through, the rotational connector configured to rotate within the fixture head; and a fixture configured to extend through the fixture head via the rotational connector, the fixture including: a first end disposed on a first side of the fixture head, and a second end disposed on a second side of the fixture head.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a schematic illustration of an embodiment of a device in accordance with an aspect of the invention;

FIG. 2 shows a schematic perspective illustration of an embodiment of a fixture head in accordance with an aspect of the invention;

FIG. 3 shows a schematic exploded illustration of an embodiment of a device in accordance with an aspect of the invention;

FIG. 4 shows a schematic illustration of an embodiment of a drill chuck in accordance with an aspect of the invention;

FIG. 5 shows a perspective schematic illustration of an embodiment of a fixture head in accordance with an aspect of the invention;

FIG. 6 shows a schematic illustration of an embodiment of a fixture head in accordance with an aspect of the invention;

FIG. 7 shows a schematic illustration of an embodiment of a device in accordance with an aspect of the invention;

FIG. 8 shows a schematic illustration of portions of a multi-shaft combined cycle power plant in accordance with an aspect of the invention; and

FIG. 9 shows a schematic illustration of portions of a single-shaft combined cycle power plant in accordance with an aspect of the invention.

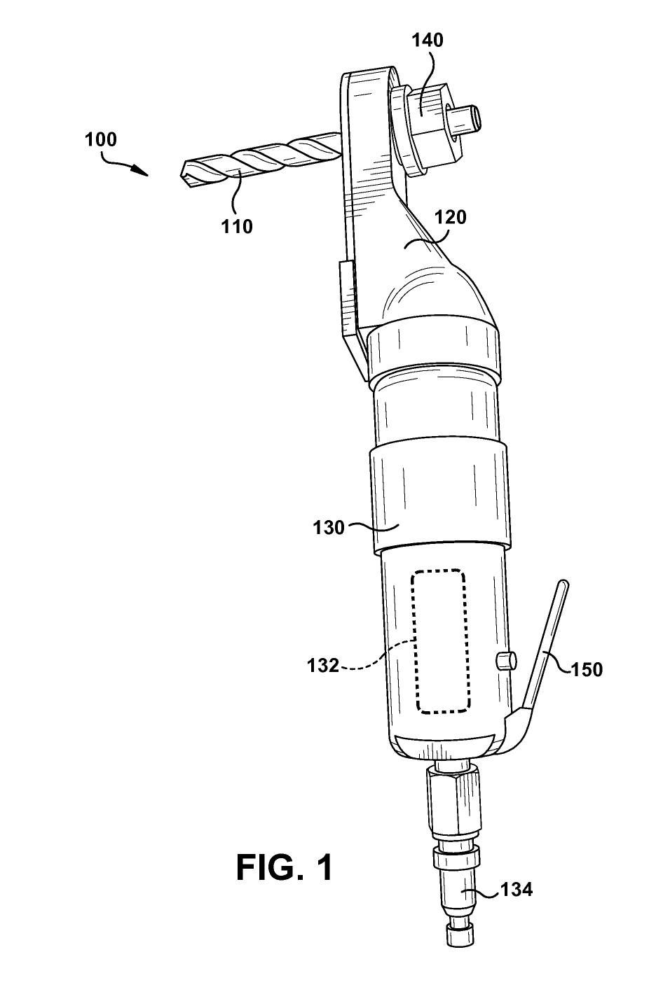

It is noted that the drawings of the invention are not necessarily to scale. The drawings are intended to depict only typical aspects of the invention, and therefore should not be considered as limiting the scope of the invention. It is understood that elements similarly numbered between the FIGURES may be substantially similar as described with reference to one another. Further, in embodiments shown and described with reference to FIGS. 1-9, like numbering may represent like elements. Redundant explanation of these elements has been omitted for clarity. Finally, it is understood that the components of FIGS. 1-9 and their accompanying descriptions may be applied to any embodiment described herein.

### DETAILED DESCRIPTION OF THE INVENTION

As indicated herein, aspects of the invention provide for systems and devices adapted to perform maintenance processes on turbomachines, particularly turbine rotors. These systems include a device with a base housing and a fixture head configured to operably connect with a rotational connector. The rotational connector defines an aperture through the fixture head through which a fixture (e.g., a drill bit, a reamer, etc.) may be adjustably disposed. During operation a technician may slide and/or secure the fixture within the rotational connector, performing a plurality of processes with the fixture in different positions relative to the fixture head. This fixture adjustability provides a versatile tool for maintenance processes which may be modified/adjusted during a procedure to accommodate for varying hole depth or other component characteristics without the need for removal and/or replacement of the fixture.

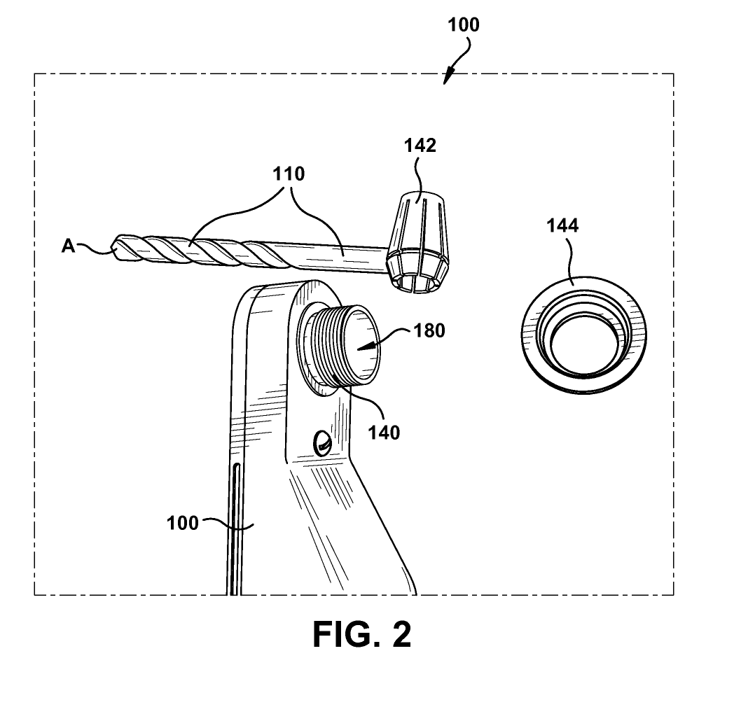

Turning to the FIGURES, embodiments of systems and devices for performing maintenance processes on turbomachines are shown, where the systems may increase accessibility, efficiency, and versatility in maintenance processes, by providing a variable length fixture. Each of the components in the FIGURES may be connected via conventional means, e.g., via an interference fit, collet, magnet, bolt, or other known means as is indicated in FIGS. 1-9. Specifically, referring to FIG. 1, a schematic illustration of a device 100 including a fixture 110 (e.g., a drill bit, a reamer, etc.) connected to a fixture head 120 via a rotational connector 140 is shown in accordance with aspects of the invention. Device 100 may include a base housing 130 connected to fixture head 120 and configured to connect to a power source (e.g., a compressed gas supply, a compressed fluid supply, an electrical supply, etc.) via an adapter 134. An engine 132 (shown in phantom) may be disposed within base housing 130 and connected to a control 150 which may enable operation of engine 132 and/or device 100 by a technician. In an embodiment, fixture head 120 may define an aperture 180 (shown in FIG. 2) through device 100, and rotational connector 140 may be disposed within aperture 180. Rotational connector 140 may be operably connected to fixture head 120, base housing 130, and/or engine 132. Fixture 110 may slidingly connect to rotational connector 140 and extend through aperture 180 and/or rotational connector 140. During operation, engine 132 may rotate fixture 110 and/or rotational connector 140 relative to fixture head 120 and/or base housing 130. In an embodiment, fixture 110 may be adjustably secured (e.g., fixture 110 may be secured at a number of locations/points within aperture 180) within rotational connector 140.

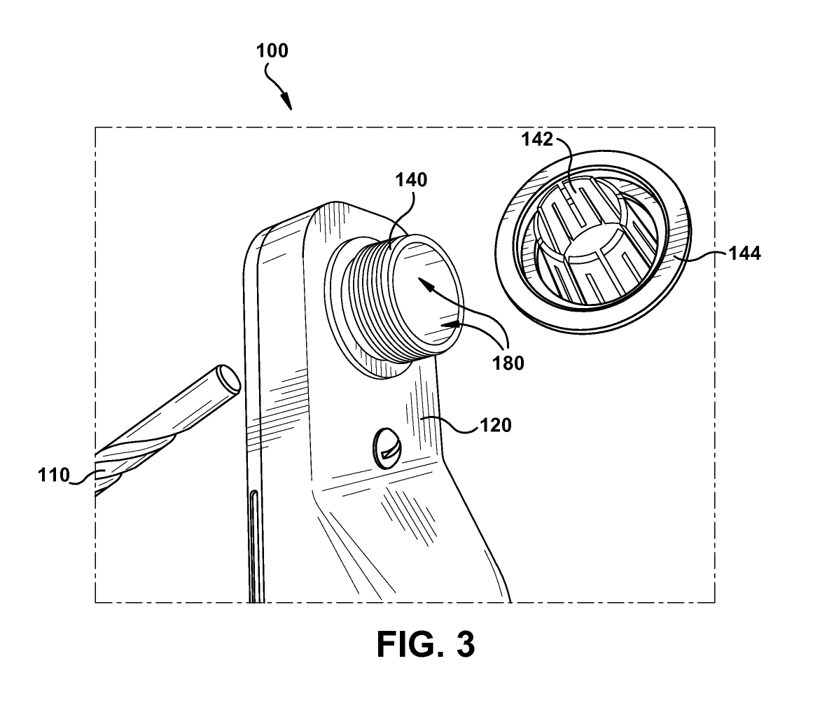

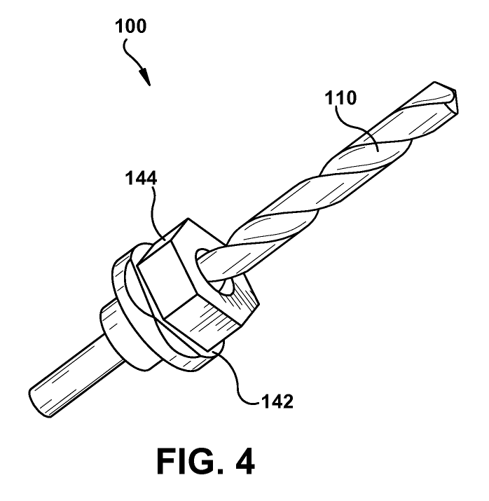

Turning to FIG. 2, a schematic illustration of portions of device 100 are shown according to embodiments of the invention. In an embodiment, device 100 may include a collet 142 and a collet cap 144. Collet 142 may be configured to slidingly receive and/or secure/connect to fixture 110, and collet cap 144 may connect to rotational connector 140 and/or collet 142. Collet cap 144 may secure collet 142 within aperture 180 and adjust a diameter of collet 142. In one embodiment, fixture 110 may be disposed/extend through aperture 180, rotational connector 140, collet 142, and collet cap 144. A position of a first end ‘A’ of fixture 110 may be adjustable relative to fixture head 120. In an embodiment, collet cap 144 may be adjusted about collet 142 so as to secure and/or release fixture 110 from collet 142, thereby enabling sliding/repositioning of first end A of fixture 110 relative to fixture head 120. In one embodiment, during operation, a technician may unscrew collet cap 144 from collet 142 and/or rotational connector 140 so as to enable adjustment/sliding of fixture 110 through aperture 180 and/or collet 142. Once fixture 110 is positioned/slid to a location desired by the technician, collet cap may be rescrewed about collet 142 and/or on rotational connector 140 to secure/squeeze fixture 110 within collet 142. As shown in FIG. 3, collet cap 144 may be disposed about collet 142 and configured to connect with rotational connector 140. Adjustment of collet cap 144 about collet 142 and/or rotational connector 140 may manipulate/control a diameter ‘K’ of collet 142. During maintenance processes, a technician may adjust collet cap 144 so as to allow insertion of fixture 110 within collet 142 and to secure fixture 110 within collet 142, as shown in FIG. 4. Collet 142 may engage/secure fixture 110 as collet cap reduces diameter K to a distance which is equivalent to a width of fixture 110. In this manner, collet cap 144 may be partially unscrewed about collet 142 to release/reposition fixture 110, which may be slid within collet 142 to a new position where collet cap 144 may be retightened.

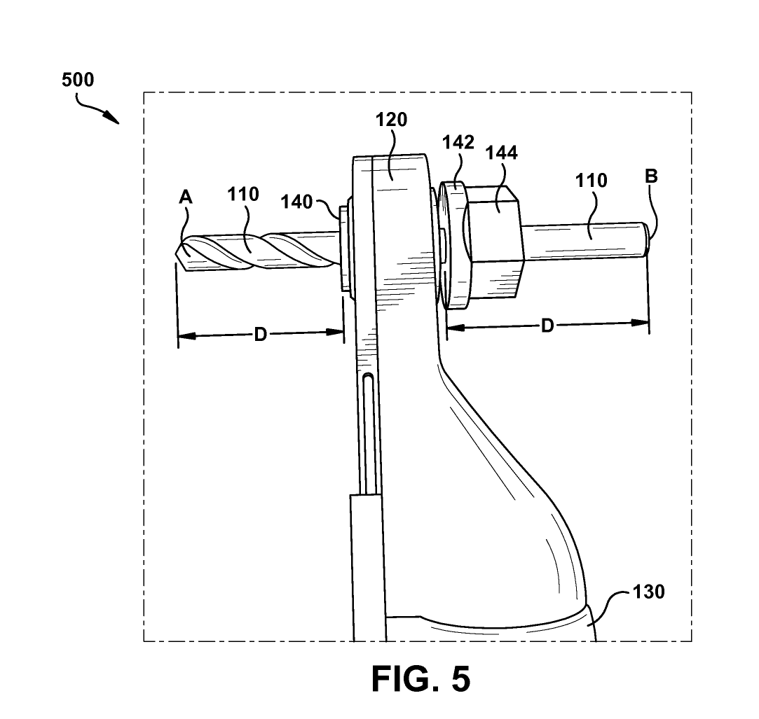

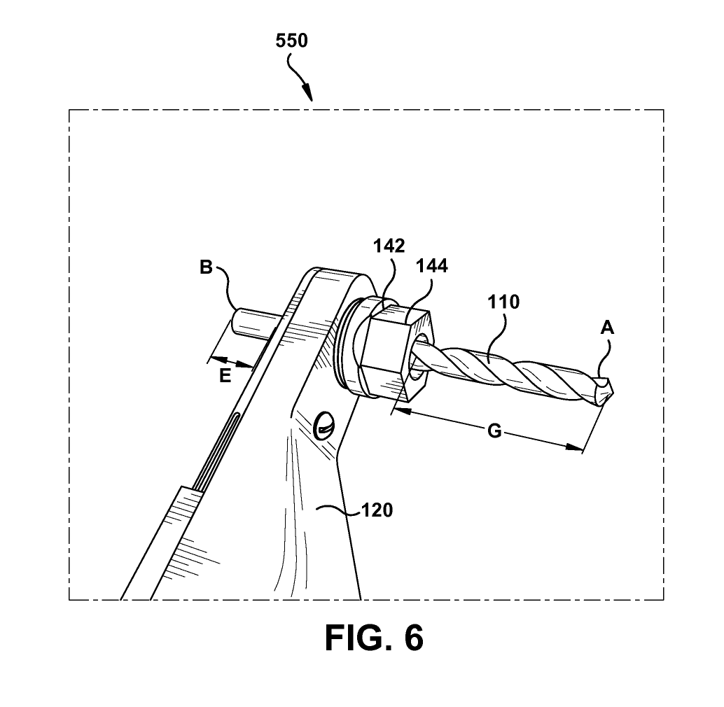

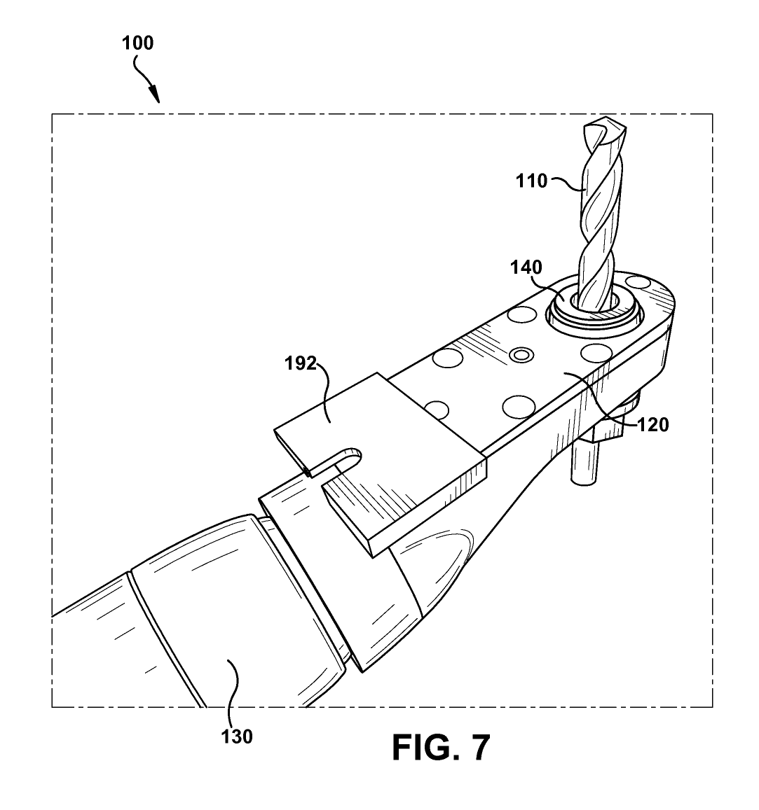

Turning to FIG. 5, a schematic illustration of portions of a device 500 are shown with fixture 110 extending through fixture head 120 according to embodiments. Fixture 110 includes first end A disposed on a first side of aperture 180, and second end B disposed on a second side of aperture 180. In this embodiment, second end B and first end A are located proximate fixture head 120 at a substantially equivalent distance ‘D.’ Collet cap 144 is connected to collet 142 and rotational connector 140, and disposed about collet 142 so as to decrease the diameter of collet 142 and form an interference fit with fixture 110, thereby securing fixture 110 within aperture 180 and/or fixture head 120 at this position. In another embodiment, shown in FIG. 6, a device 550 includes second end B which may be disposed at a distance ‘E’ relative to fixture head 120 which is much less than a distance ‘G’ between fixture head 120 and first end A. In an embodiment, a technician may adjust a position of fixture 110 to switch between device 500 and device 550 by adjusting collet cap 144 to slide and secure fixture 110 within collet 142 and rotational connector 140. In another embodiment, shown in FIG. 7, a backplate 192 may be disposed on fixture head 120. Backplate 192 may be slidingly disposed on fixture head 120 and may substantially cover a spindle lock.

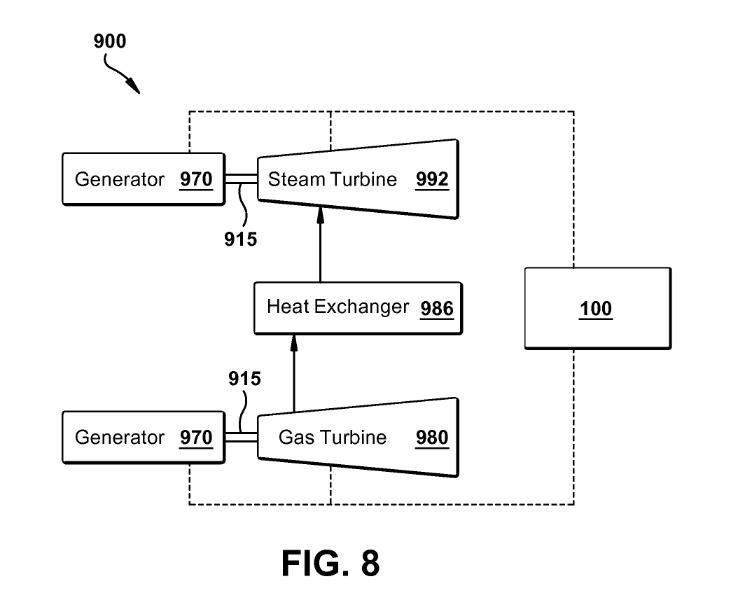

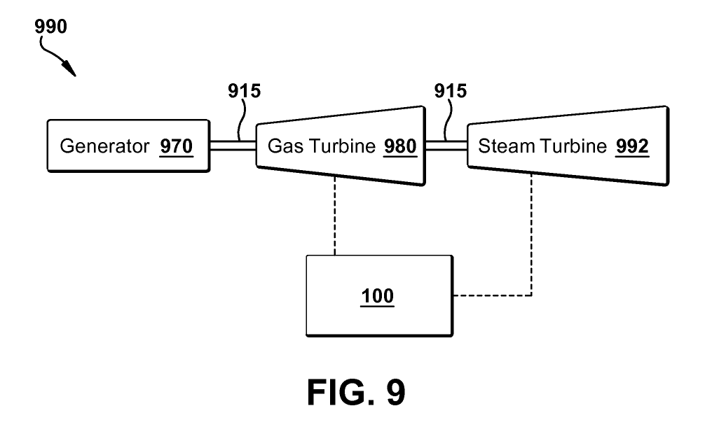

Turning to FIG. 8, a schematic view of portions of a multi-shaft combined-cycle power plant 900 is shown. Combined-cycle power plant 900 may include, for example, a gas turbine 942 operably connected to a generator 944. Generator 944 and gas turbine 942 may be mechanically coupled by a shaft 911, which may transfer energy between a drive shaft (not shown) of gas turbine 942 and generator 944. Gas turbine 942 may be connected to device 100 of FIG. 1 or other embodiments described herein. Also shown in FIG. 8 is a heat exchanger 946 operably connected to gas turbine 942 and a steam turbine 948. Heat exchanger 946 may be fluidly connected to both gas turbine 942 and steam turbine 948 via conventional conduits (numbering omitted). Heat exchanger 946 may be a conventional heat recovery steam generator (HRSG), such as those used in conventional combined-cycle power systems. As is known in the art of power generation, HRSG 946 may use hot exhaust from gas turbine 942, combined with a water supply, to create steam which is fed to steam turbine 948. Steam turbine 948 may optionally be coupled to a second generator system 944 (via a second shaft 911). It is understood that generators 944 and shafts 911 may be of any size or type known in the art and may differ depending upon their application or the system to which they are connected. Common numbering of the generators and shafts is for clarity and does not necessarily suggest these generators or shafts are identical. Generator system 944 and second shaft 911 may operate substantially similarly to generator system 944 and shaft 911 described above. Steam turbine 948 may be connected to device 100 of FIG. 1 or other embodiments described herein. In one embodiment of the present invention (shown in phantom), device 100 may be used to perform maintenance processes in either or both of steam turbine 948 and gas turbine 942. In another embodiment, shown in FIG. 9, a single-shaft combined-cycle power plant 990 may include a single generator 944 coupled to both gas turbine 942 and steam turbine 946 via a single shaft 911. Gas turbine 942 and steam turbine 946 may be connected to device 100 of FIG. 1 or other embodiments described herein.

The system of the present disclosure is not limited to any one particular machine, driven machine, turbine, fan, blower, compressor, power generation system or other system, and may be used with other power generation systems and/or systems (e.g., combined-cycle, simple-cycle, nuclear reactor, etc.). Additionally, the systems and devices of the present invention may be used with other systems not described herein that may benefit from the versatility, mobility, and functionality of the systems and devices described herein.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A device comprising:
a base housing;
a fixture head connected to the base housing, the fixture head including an aperture therethrough;
a rotational connector disposed within the aperture and configured to rotate within the aperture; and
a fixture slidingly connected to the fixture head via the rotational connector, the fixture extending through the aperture.

2. The device of claim 1, wherein the rotational connector includes:
a collet disposed within the aperture, the collet configured to slidingly receive the fixture, and
a collet cap connected to the collet and configured to adjust a diameter of the collet.

3. The device of claim 1, wherein the fixture is disposed at a substantially right angle relative to the base.

4. The device of claim 1, wherein the fixture includes at least one of: a drill bit and a reamer.

5. The device of claim 1, further comprising an engine disposed within the base housing and operatively connected to the rotational connector, the engine configured to rotate the rotational connector and fixture within the aperture defined by the fixture head.

6. The device of claim 1, wherein the base is configured to operably connect to a power source.

7. The device of claim 6, wherein the power source includes at least one of: an electrical source and a pneumatic source.

8. A system comprising:
a turbine;
a device connected to the turbine, the device including:
a base housing, and
a fixture head connected to the base housing, the fixture head defining an aperture through the device;
a rotational connector disposed within the aperture and operably connected to the device, the rotational connector configured to rotate within the aperture; and
a fixture configured to slidingly connect to the fixture head at a plurality of locations via the rotational connector, the fixture further configured to extend through the aperture.

9. The system of claim 8, wherein the rotational connector includes:
a collet disposed within the aperture, the collet configured to slidingly receive the fixture, and
a collet cap connected to the collet and configured to adjust a diameter of the collet.

10. The system of claim 8, wherein the fixture is disposed at a substantially right angle relative to the base.

11. The system of claim 8, wherein the fixture includes at least one of: a drill bit and a reamer.

12. The system of claim 8, further comprising an engine disposed within the base housing and operatively connected to the rotational connector, the engine configured to rotate the rotational connector and fixture within the aperture defined by the fixture head.

13. The system of claim 8, wherein the base is configured to operably connect to a power source.

14. The system of claim 13, wherein the power source includes at least one of: an electrical source and a pneumatic source.

15. A device comprising:
a rotational connector configured to connect to a fixture head and define an aperture there through, the rotational connector configured to rotate within the fixture head; and
a fixture configured to extend through the fixture head via the rotational connector, the fixture including:
a first end disposed on a first side of the fixture head, and
a second end disposed on a second side of the fixture head.

16. The device of claim 15, wherein the rotational connector includes:
a collet disposed within the aperture, the collet configured to slidingly receive the fixture, and
a collet cap connected to the collet and configured to adjust a diameter of the collet.

17. The device of claim 15, wherein the fixture is disposed at a substantially right angle relative to the fixture head.

18. The device of claim 15, wherein the fixture includes at least one of: a drill bit and a reamer.

19. The device of claim 15, wherein a position of the first end relative to the fixture head is manipulated by the rotational connector.

20. The device of claim 15, wherein the base is configured to operably connect to at least one of: an electrical source and a pneumatic source.
